(19) United States
(12) Patent Application Publication
(10) Pub. No.: US 2025/0355248 A1
(43) Pub. Date: Nov. 20, 2025

(54) HOLOGRAPHIC WAVEGUIDE LENS AND PREPARATION METHOD THEREOF

(71) Applicant: Nanchang Virtual Reality Research Institute Co., Ltd., Nanchang (CN)

(72) Inventors: Mingli Ni, Nanchang (CN); Song Yang, Nanchang (CN)

(21) Appl. No.: 19/286,141

(22) Filed: Jul. 30, 2025

Related U.S. Application Data
(63) Continuation of application No. PCT/CN2023/137657, filed on Dec. 8, 2023.

(30) Foreign Application Priority Data
Mar. 1, 2023 (CN) 202310185938.4

(51) Int. Cl. G02B 27/01; G02F 1/1343

(52) U.S. Cl. CPC G02B 27/0103; G02F 1/13439; G02B 2027/0105; G02B 2027/0118

(57) ABSTRACT

The present application provides a holographic waveguide lens and a preparation method thereof, the holographic waveguide lens including a first lens substrate, a second lens substrate, an in-coupling grating, an out-coupling grating, a first transparent electrode, and a second transparent electrode. The first transparent electrode, the out-coupling grating, and the second transparent electrode are collectively divided into a plurality of sub-regions, and a voltage between the first transparent electrode and the second transparent electrode for each sub-region is set based on an electro-optical response curve and a diffraction efficiency of a polymer-dispersed liquid crystal holographic grating in the sub-region. By applying an adjustable voltage to the out-coupling grating located between the first lens substrate and the second lens substrate using the first transparent electrode and the second transparent electrode, the diffraction efficiency of different regions of the out-coupling grating is adjusted, thereby improving the uniformity of exit pupil light.

### CROSS REFERENCE TO RELATED APPLICATIONS

This application is a Continuation application of PCT Application No. PCT/CN2023/137657 filed on Dec. 8, 2023, which claims priority to Chinese Patent Application No. 202310185938.4, filed with the China National Intellectual Property Administration on Mar. 1, 2023 and entitled “HOLOGRAPHIC WAVEGUIDE LENS AND PREPARATION METHOD THEREOF,” which is incorporated herein by reference in its entirety.

### TECHNICAL FIELD

The present application relates to the technical field of projection devices, and in particular, to a holographic waveguide lens and a preparation method thereof.

### BACKGROUND

Grating waveguide display technology is a mainstream development direction in the field of augmented reality (Augmented Reality, AR). Its principle involves coupling light into a lens through diffraction by a grating, propagating the light within the waveguide lens by total internal reflection, and diffracting the light out of the waveguide lens upon encountering an out-coupling grating to enter the human eye.

Ensuring the uniformity of light output in the exit pupil region is one of the key technologies in grating waveguide AR displays. In the prior art, designing and preparing gratings with diffraction efficiency that gradually increases along the light propagation path is a common approach to improve output uniformity. However, this method is not only extremely difficult to implement in actual production but also limited to preparing gratings with gradually varying diffraction efficiency, unable to precisely control the diffraction efficiency of each out-coupling grating in distinct regions, resulting in still insufficiently uniform output light.

### SUMMARY

Embodiments of the present application provide a holographic waveguide lens and a preparation method thereof to address the above technical issues.

The embodiments of the present application achieve the above objectives through the following technical solutions.

According to a first aspect, the present application provides a holographic waveguide lens, including: a first lens substrate, a second lens substrate, an in-coupling grating, an out-coupling grating, a first transparent electrode, and a second transparent electrode. The first lens substrate includes a first surface. The second lens substrate includes a second surface, where the second surface is opposite to the first surface. The in-coupling grating and the out-coupling grating are disposed between the first lens substrate and the second lens substrate, where the in-coupling grating and the out-coupling grating are both polymer-dispersed liquid crystal holographic gratings. The first transparent electrode is formed on a region of the first surface corresponding to the out-coupling grating. The second transparent electrode is formed on a region of the second surface corresponding to the out-coupling grating. The first transparent electrode, the out-coupling grating, and the second transparent electrode are collectively divided into a plurality of sub-regions, and a voltage between the first transparent electrode and the second transparent electrode for each sub-region is set based on an electro-optical response curve and a diffraction efficiency of the polymer-dispersed liquid crystal holographic grating in the sub-region.

In some embodiments, a thickness of the polymer-dispersed liquid crystal holographic grating is 2 μm to 10 μm.

In some embodiments, the in-coupling grating and the out-coupling grating are arranged along a first direction, and lengths of the out-coupling grating, the first transparent electrode, and the second transparent electrode in the first direction are equal.

In some embodiments, thicknesses of the first lens substrate and the second lens substrate are 0.5 mm to 4 mm.

In some embodiments, the number of the plurality of sub-regions is 5 to 15.

In some embodiments, a voltage of each sub-region is independently controlled.

According to another aspect, an embodiment of the present application provides a preparation method of a holographic waveguide lens, including the following steps:
mixing a photopolymer monomer, a liquid crystal, and a photoinitiator in a light-shielded container uniformly to prepare a polymer-dispersed liquid crystal holographic grating raw material;
forming a first transparent electrode on a region of a first lens substrate corresponding to an out-coupling grating, where the first transparent electrode includes a plurality of sub-regions;
forming a second transparent electrode on a region of a second lens substrate corresponding to the out-coupling grating, where the second transparent electrode includes a plurality of sub-regions corresponding to the first transparent electrode;
stacking the first lens substrate, the polymer-dispersed liquid crystal holographic grating raw material, and the second lens substrate, and aligning the first transparent electrode opposite to the second transparent electrode to form a lens intermediate;
preparing a polymer-dispersed liquid crystal holographic grating in an in-coupling grating region and an out-coupling grating region using a holographic exposure method; and
setting a voltage between the first transparent electrode and the second transparent electrode for each sub-region based on an electro-optical response curve and a diffraction efficiency of the polymer-dispersed liquid crystal holographic grating for each sub-region to obtain the holographic waveguide lens.

In some embodiments, the setting a voltage between the first transparent electrode and the second transparent electrode for each sub-region based on an electro-optical response curve and a diffraction efficiency of the polymer-dispersed liquid crystal holographic grating for each sub-region includes:
measuring the polymer-dispersed liquid crystal holographic grating using a liquid crystal display parameter tester to obtain the electro-optical response curve of the polymer-dispersed liquid crystal holographic grating;
calculating diffraction efficiencies required for different sub-regions of the out-coupling grating to achieve a uniform exit pupil for the lens intermediate; and
setting a voltage between the first transparent electrode and the second transparent electrode for different sub-regions based on the electro-optical response curve and the diffraction efficiencies required for different sub-regions of the out-coupling grating to obtain the holographic waveguide lens.

In some embodiments, the calculating diffraction efficiencies required for different sub-regions of the out-coupling grating to achieve a uniform exit pupil for the lens intermediate includes:
setting a preset diffraction efficiency corresponding to each sub-region;
calculating a product of the preset diffraction efficiency corresponding to each sub-region and a remaining energy after coupling out from all sub-regions preceding the sub-region in the first direction, as an out-coupled energy of the sub-region; and
using a genetic algorithm to minimize a standard deviation of the out-coupled energies among the sub-regions, and calculating the diffraction efficiencies required for different sub-regions of the out-coupling grating.

In some embodiments, the diffraction efficiency of the polymer-dispersed liquid crystal holographic grating is adjustable between 5% and 99% with changes in an applied voltage.

The holographic waveguide lens and the preparation method thereof provided by the embodiments of the present application improve the uniformity of exit pupil light by disposing the first transparent electrode and the second transparent electrode on the first lens substrate and the second lens substrate, and applying an adjustable voltage to the out-coupling grating located between the first lens substrate and the second lens substrate using the first transparent electrode and the second transparent electrode to adjust the diffraction efficiency of different regions of the out-coupling grating.

### BRIEF DESCRIPTION OF DRAWINGS

To more clearly illustrate the technical solutions in the embodiments of the present application, the drawings required for describing the embodiments are briefly introduced below. It is apparent that the drawings described below are only some embodiments of the present application, and those skilled in the art can obtain other drawings based on these drawings without creative efforts.

FIG. 1 is a schematic structural diagram of a holographic waveguide lens provided by an embodiment of the present application.

FIG. 2 is an exploded view from a first perspective of a structure of a holographic waveguide lens provided by an embodiment of the present application.

FIG. 3 is an exploded view from a second perspective of a structure of a holographic waveguide lens provided by an embodiment of the present application.

FIG. 4 is a schematic diagram of a principle of a holographic waveguide lens provided by an embodiment of the present application.

FIG. 5 is a flowchart of a preparation method of a holographic waveguide lens provided by an embodiment of the present application.

FIG. 6 is a detailed flowchart of step S600 in a flowchart of a preparation method of a holographic waveguide lens provided by an embodiment of the present application.

FIG. 7 is a graph showing measurement of an electro-optical response curve of a polymer-dispersed liquid crystal holographic grating provided by an embodiment of the present application.

FIG. 8 is a detailed flowchart of step S610 in a flowchart of a preparation method of a holographic waveguide lens provided by an embodiment of the present application.

### REFERENCE SIGNS

holographic waveguide lens 1, first lens substrate 100, first surface 110, second lens substrate 200, second surface 210, polymer-dispersed liquid crystal holographic grating 300, in-coupling grating 310, out-coupling grating 320, first transparent electrode 400, and second transparent electrode 500.

### DETAILED DESCRIPTION

The embodiments of the present application are described in detail below, and examples of the embodiments are illustrated in the drawings, where the same or similar reference numerals throughout denote the same or similar elements or elements having the same or similar functions. The embodiments described below with reference to the drawings are exemplary and are only used to explain the present application, and should not be construed as limiting the present application.

To enable those skilled in the art to better understand the solutions of the present application, the technical solutions in the embodiments of the present application are clearly and completely described below in conjunction with the drawings in the embodiments of the present application. It is apparent that the described embodiments are only some embodiments of the present application, not all embodiments. Based on the embodiments in the present application, all other embodiments obtained by those skilled in the art without creative efforts shall fall within the protection scope of the present application.

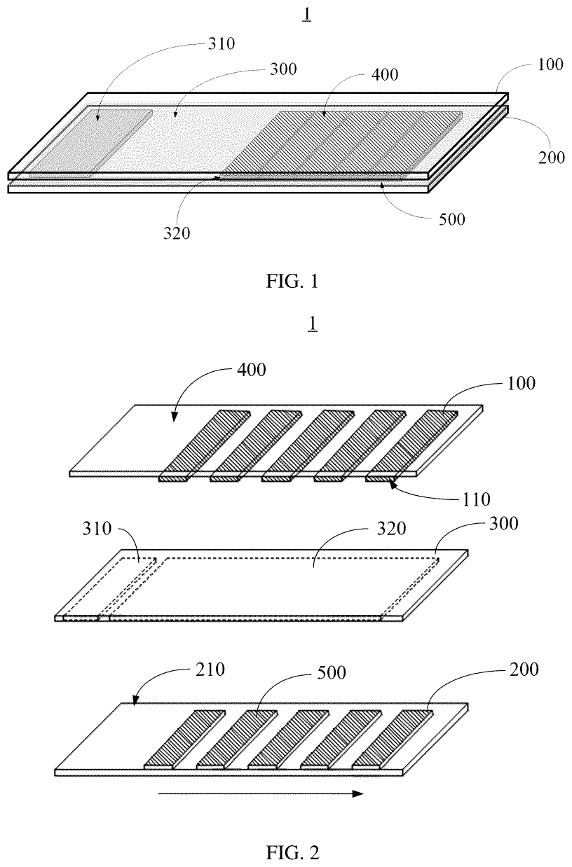

Referring to FIG. 1 to FIG. 3, the present application provides a holographic waveguide lens 1, including: a first lens substrate 100, a second lens substrate 200, an in-coupling grating 310, an out-coupling grating 320, a first transparent electrode 400, and a second transparent electrode 500.

The first lens substrate 100 includes a first surface 110. A thickness of the first lens substrate 100 is 0.5 mm to 4 mm. If the thickness of the first lens substrate 100 is less than 0.5 mm, the number of out-coupling points would be excessive, leading to an excessive number of regions to be divided for the transparent electrode, increasing the difficulty of optimization and design and raising manufacturing costs. If the lens thickness is greater than 4 mm, the AR display image is prone to discontinuity, and excessive thickness affects user experience. Therefore, in this embodiment, the thickness of the first lens substrate 100 is preferably 0.5 mm to 4 mm, for example, the thickness of the first lens substrate 100 may be 0.5 mm, 2 mm, or 4 mm, or any value within this range, such as 2.5 mm, without limitation.

The second lens substrate 200 includes a second surface 210, where the second surface 210 is opposite to the first surface 110. The thickness of the second lens substrate 200 may refer to the thickness of the first lens substrate 100, and is not repeated here.

The in-coupling grating 310 and the out-coupling grating 320 are disposed between the first lens substrate 100 and the second lens substrate 200. In this embodiment, the in-coupling grating 310 and the out-coupling grating 320 are both polymer-dispersed liquid crystal holographic gratings 300. In this embodiment, a thickness of the polymer-dispersed liquid crystal holographic grating 300 may be 2 μm to 10 μm. If the thickness of the polymer-dispersed liquid crystal holographic grating 300 is less than 2 μm, the maximum diffraction efficiency would be too low, reducing system light efficiency. If the thickness of the polymer-dispersed liquid crystal holographic grating 300 is greater than 10 μm, the driving voltage of the first transparent electrode 400 and the second transparent electrode 500 would be too high, making practical application difficult.

The first transparent electrode 400 is formed on a region of the first surface 110 corresponding to the out-coupling grating 320.

The second transparent electrode 500 is formed on a region of the second surface 210 corresponding to the out-coupling grating 320.

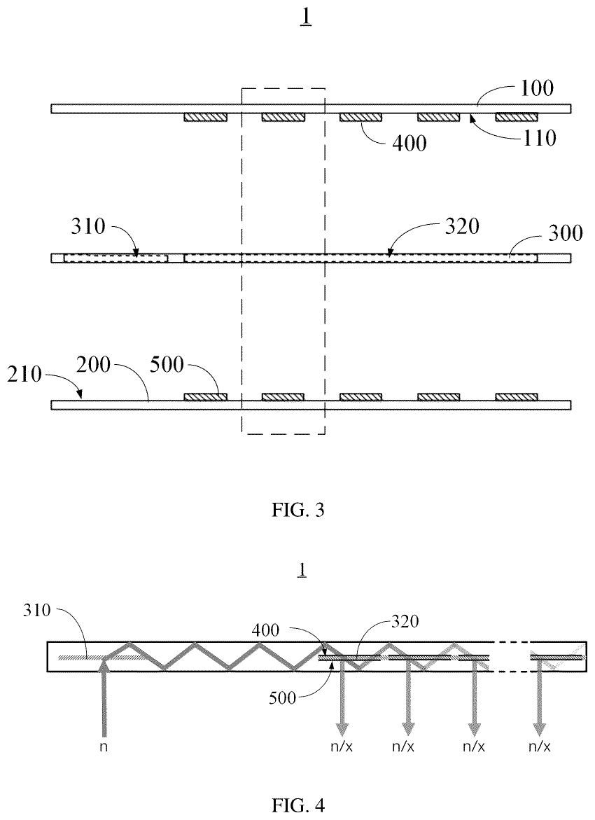

Referring to FIG. 3, the first transparent electrode 400, the out-coupling grating 320, and the second transparent electrode 500 are collectively divided into a plurality of sub-regions, where a dashed box in the figure represents one sub-region, and a voltage between the first transparent electrode 400 and the second transparent electrode 500 for each sub-region is set based on an electro-optical response curve and a diffraction efficiency of the polymer-dispersed liquid crystal holographic grating 300 in the sub-region.

The holographic waveguide lens 1 provided by the embodiments of the present application improves the uniformity of exit pupil light by disposing the first transparent electrode 400 and the second transparent electrode 500 on the first lens substrate 100 and the second lens substrate 200, and applying an adjustable voltage to the out-coupling grating 320 located between the first lens substrate 100 and the second lens substrate 200 using the first transparent electrode 400 and the second transparent electrode 500 to adjust the diffraction efficiency of different regions of the out-coupling grating 320.

Referring to FIG. 2, in some embodiments, the in-coupling grating 310 and the out-coupling grating 320 are arranged along a first direction, where the direction indicated by the arrow in the FIG. 2 is the first direction, and lengths of the out-coupling grating 320, the first transparent electrode 400, and the second transparent electrode 500 in the first direction are equal. Preferably, a length of the out-coupling grating 320 may be 10 mm to 30 mm. If the length of the out-coupling grating 320 is less than 10 mm, the exit pupil region would be too small, resulting in a limited eye movement range. If the length of the out-coupling grating 320 is greater than 30 mm, the exit pupil region would be too large, leading to wasted light energy and reduced display brightness. Therefore, in this embodiment, the length of the out-coupling grating 320 may be 14 mm, 15 mm, 20 mm, and the like. It is understood that the length of the out-coupling grating 320 may be any value within this range, such as 16.5 mm, without limitation.

In some embodiments, the number of sub-regions collectively divided by the first transparent electrode 400, the out-coupling grating 320, and the second transparent electrode 500 may be 5 to 15. If the out-coupling grating 320 is divided into fewer than 5 regions, it would be difficult to achieve light output uniformity in the exit pupil region. If the out-coupling grating 320 is divided into more than 15 regions, the system would become complex, significantly increasing design difficulty and manufacturing costs. Therefore, in this embodiment, the out-coupling grating 320 is preferably divided into 5 to 15 regions, for example, the out-coupling grating 320 may be divided into 5, 7, or 15 regions, and the like. It is understood that the number of regions divided for the out-coupling grating 320 may be any natural number within this range, for example, the out-coupling grating 320 may also be divided into 10 regions, without limitation.

In some embodiments, the thickness of the first lens substrate 100 and the second lens substrate 200 in the holographic waveguide lens 1 is 4 mm, the first transparent electrode 400 and the second transparent electrode 500 are each divided into 5 regions with independently controllable voltages, the length of the first transparent electrode 400 and the second transparent electrode 500 is 20 mm, the thickness of the polymer-dispersed liquid crystal holographic grating 300 is 3 μm, and the diffraction efficiency of the polymer-dispersed liquid crystal holographic grating 300 is continuously adjustable between 11% and 99%. The diffraction efficiencies of the five regions of the out-coupling grating 320 are 20%, 25%, 33.3%, 50%, and 99%, respectively. Based on the electro-optical response curve of the polymer-dispersed liquid crystal holographic grating 300, the driving voltage for each region is set.

In other embodiments, the thickness of the first lens substrate 100 and the second lens substrate 200 in the holographic waveguide lens 1 is 2 mm, the first transparent electrode 400 and the second transparent electrode 500 are each divided into 7 regions with independently controllable voltages, the length of the first transparent electrode 400 and the second transparent electrode 500 is 14 mm, the thickness of the polymer-dispersed liquid crystal holographic grating 300 is 10 μm, and the diffraction efficiency of the polymer-dispersed liquid crystal holographic grating 300 is continuously adjustable between 5% and 80%. The diffraction efficiencies of the seven regions of the out-coupling grating 320 are 13.8%, 16%, 19%, 23.5%, 30.8%, 44.4%, and 80%, respectively. Based on the electro-optical response curve of the polymer-dispersed liquid crystal holographic grating 300, the driving voltage for each region is set.

In yet other embodiments, the thickness of the first lens substrate 100 and the second lens substrate 200 in the holographic waveguide lens 1 is 0.5 mm, the first transparent electrode 400 and the second transparent electrode 500 are each divided into 15 regions with independently controllable voltages, the length of the first transparent electrode 400 and the second transparent electrode 500 is 15 mm, the thickness of the polymer-dispersed liquid crystal holographic grating 300 is 2 μm, and the diffraction efficiency of the polymer-dispersed liquid crystal holographic grating 300 is continuously adjustable between 5% and 80%. The diffraction efficiencies of the fifteen regions of the out-coupling grating 320 are 6.6%, 7%, 7.5%, 8.2%, 8.9%, 9.8%, 10.8%, 12.1%, 13.8%, 16%, 19%, 23.5%, 30.8%, 44.4%, and 80%, respectively. Based on the electro-optical response curve of the polymer-dispersed liquid crystal holographic grating 300, the driving voltage for each region is set.

Referring to FIG. 4, ignoring light intensity loss during propagation and assuming the incident and exit light angles satisfy the Bragg condition, when using a uniform grating with a diffraction efficiency of 50% for coupling out, the light intensity of the incident light with intensity n at the x-th coupling-out is n/2x. In the embodiments of the present application, x first transparent electrodes 400 may be disposed on the first lens substrate 100, x second transparent electrodes 500 may be disposed on the second lens substrate 200, and the out-coupling grating 320 may be divided into x sub-regions. By varying the voltage applied to the first transparent electrode 400 and the second transparent electrode 500, the diffraction efficiency of each sub-region is independently controlled, so that under the same conditions, the intensity of each exit light beam is closer to n/x, improving the uniformity of the exit light.

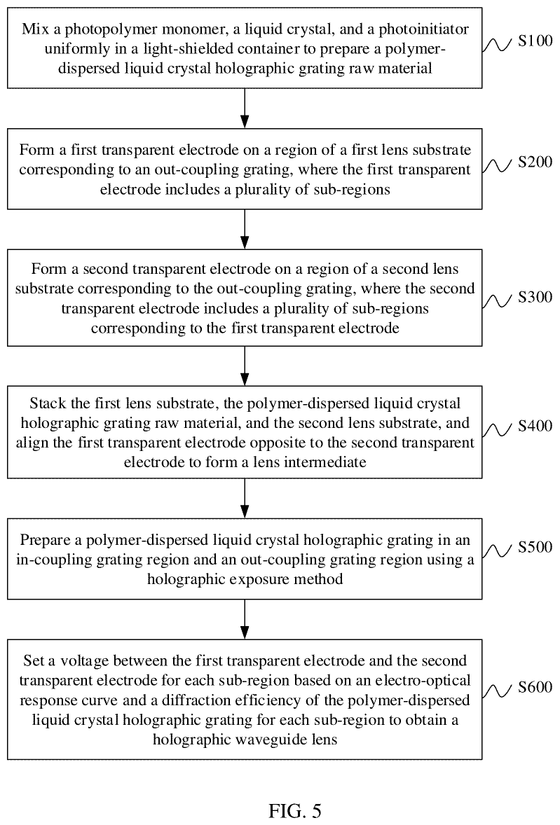

Referring to FIG. 5, an embodiment of the present application further provides a preparation method of a holographic waveguide lens for preparing the holographic waveguide lens in the above embodiments, where the preparation method may include the following steps:
S100: Mixing a photopolymer monomer, a liquid crystal, and a photoinitiator in a light-shielded container uniformly to prepare a polymer-dispersed liquid crystal holographic grating raw material.

It should be noted that uniform mixing here may be understood as using ultrasound or stirring until the liquid in the container appears transparent, which can be considered uniformly mixed.
S200: Forming a first transparent electrode on a region of a first lens substrate corresponding to an out-coupling grating, where the first transparent electrode includes a plurality of sub-regions.

It is understood that the formation may involve manually installing the first transparent electrode on the first lens substrate after its production, or directly preparing and installing the first transparent electrode during the production of the first lens substrate to obtain a first lens substrate with the first transparent electrode, without limitation.
S300: Forming a second transparent electrode on a region of a second lens substrate corresponding to the out-coupling grating, where the second transparent electrode includes a plurality of sub-regions corresponding to the first transparent electrode.

The formation of the second transparent electrode may refer to the formation of the first transparent electrode, and is not repeated here.
S400: Stacking the first lens substrate, the polymer-dispersed liquid crystal holographic grating raw material, and the second lens substrate, and aligning the first transparent electrode opposite to the second transparent electrode to form a lens intermediate.

It should be noted that both the first transparent electrode and the second transparent electrode are disposed in the out-coupling grating region.
S500: Preparing a polymer-dispersed liquid crystal holographic grating in an in-coupling grating region and an out-coupling grating region using a holographic exposure method.
S600: Setting a voltage between the first transparent electrode and the second transparent electrode for each sub-region based on an electro-optical response curve and a diffraction efficiency of the polymer-dispersed liquid crystal holographic grating for each sub-region to obtain the holographic waveguide lens.

It should be noted that the electro-optical response curve of the polymer-dispersed liquid crystal holographic grating may be measured using a liquid crystal display parameter tester.

The holographic waveguide lens prepared by the above method improves the uniformity of exit pupil light by disposing the first transparent electrode and the second transparent electrode on the first lens substrate and the second lens substrate, and applying an adjustable voltage to the out-coupling grating located between the first lens substrate and the second lens substrate using the first transparent electrode and the second transparent electrode to adjust the diffraction efficiency of different regions of the out-coupling grating.

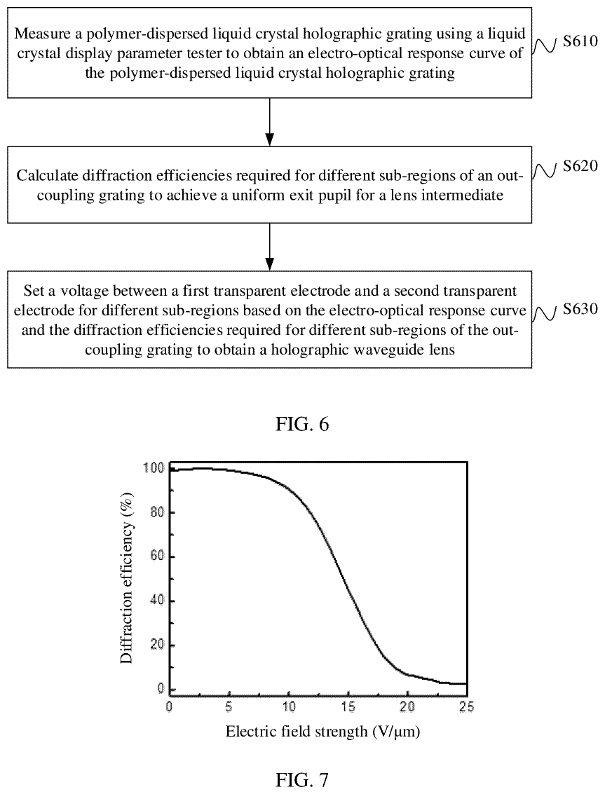

Referring to FIG. 6, in some embodiments, step S600 may include:
S610: Measuring the polymer-dispersed liquid crystal holographic grating using a liquid crystal display parameter tester to obtain the electro-optical response curve of the polymer-dispersed liquid crystal holographic grating.

Specifically, the measurement voltage may be set to 1 kHz, 0 V to 280 V, and a 633 nm p-polarized laser may be used to incident from the Bragg angle during testing. In this measurement, the diffraction efficiency is defined as diffraction light intensity/(diffraction light intensity+transmission light intensity). The electro-optical response curve of the polymer-dispersed liquid crystal holographic grating may refer to FIG. 7.
S620: Calculating diffraction efficiencies required for different sub-regions of the out-coupling grating to achieve a uniform exit pupil for the lens intermediate.

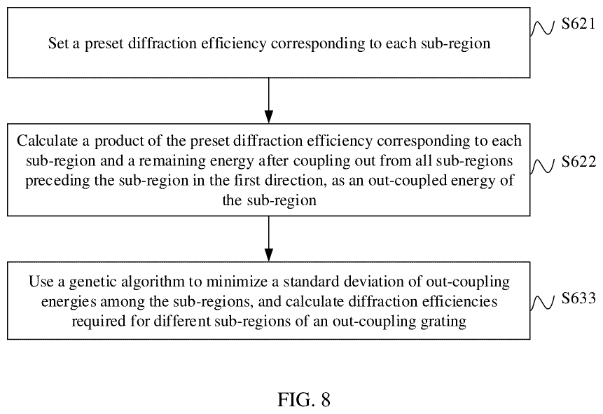

Referring to FIG. 8, specifically, this step may include:
S621: Setting a preset diffraction efficiency corresponding to each sub-region.
S622: Calculating a product of the preset diffraction efficiency corresponding to each sub-region and a remaining energy after coupling out from all sub-regions preceding the sub-region in the first direction, as an out-coupled energy of the sub-region.
S623: Using a genetic algorithm to minimize a standard deviation of the out-coupled energies among the sub-regions, and calculating the diffraction efficiencies required for different sub-regions of the out-coupling grating.
S630: Setting a voltage between the first transparent electrode and the second transparent electrode for different sub-regions based on the electro-optical response curve and the diffraction efficiencies required for different sub-regions of the out-coupling grating to obtain the holographic waveguide lens.

For example, dividing the out-coupling grating into 5 sub-regions and using a genetic algorithm, the diffraction efficiencies of the sub-regions arranged in the first direction to achieve uniform output of the out-coupling grating are 20%, 25%, 33.3%, 50%, and 99%, respectively. Combined with the electro-optical response curve shown in FIG. 3, the voltages to be applied to the sub-regions arranged in the first direction are 55.1 V, 53.1 V, 50.1 V, 45.6 V, and 0 V, respectively.

In some embodiments, the diffraction efficiency of the polymer-dispersed liquid crystal holographic grating is adjustable between 5% and 99% with changes in an applied voltage. That is, the diffraction efficiency of the polymer-dispersed liquid crystal holographic grating changes with the magnitude of the applied voltage. In this embodiment, the regulation range of the diffraction efficiency of the polymer-dispersed liquid crystal holographic grating is set between 5% and 99%. Referring again to FIG. 4, if the diffraction efficiency of the polymer-dispersed liquid crystal holographic grating is less than 5%, it would be difficult to ensure the uniformity of light output in the exit pupil region.

In summary, the holographic waveguide lens prepared by the embodiments of the present application improves the uniformity of exit pupil light by disposing the first transparent electrode and the second transparent electrode on the first lens substrate and the second lens substrate, and applying an adjustable voltage to the out-coupling grating located between the first lens substrate and the second lens substrate using the first transparent electrode and the second transparent electrode to adjust the diffraction efficiency of different regions of the out-coupling grating.

The description of terms such as “some embodiments” and “other embodiments” means that the specific features, structures, materials, or characteristics described in connection with the embodiment or example are included in at least one embodiment or example of the present application. In the present application, the schematic expressions of the above terms do not necessarily refer to the same embodiment or example. Moreover, the described specific features, structures, materials, or characteristics may be combined in any suitable manner in any one or more embodiments or examples. Furthermore, without contradiction, those skilled in the art may combine and integrate different embodiments or examples described in the present application and the features of different embodiments or examples.

The above embodiments are only used to illustrate the technical solutions of the present application and are not intended to limit it. Although the present application has been described in detail with reference to the foregoing embodiments, those of ordinary skill in the art should understand that the technical solutions described in the foregoing embodiments may still be modified, or some technical features may be equivalently replaced; such modifications or replacements do not cause the essence of the corresponding technical solutions to depart from the spirit and scope of the technical solutions of the embodiments of the present application and should be included within the protection scope of the present application.

1. A holographic waveguide lens, comprising:
a first lens substrate comprising a first surface;
a second lens substrate comprising a second surface, wherein the second surface is opposite to the first surface;
an in-coupling grating and an out-coupling grating disposed between the first lens substrate and the second lens substrate, wherein the in-coupling grating and the out-coupling grating are both polymer-dispersed liquid crystal holographic gratings;
a first transparent electrode formed on a region of the first surface corresponding to the out-coupling grating; and
a second transparent electrode formed on a region of the second surface corresponding to the out-coupling grating;
wherein the first transparent electrode, the out-coupling grating, and the second transparent electrode are collectively divided into a plurality of sub-regions, and a voltage between the first transparent electrode and the second transparent electrode for each sub-region is set based on an electro-optical response curve and a diffraction efficiency of the polymer-dispersed liquid crystal holographic grating in the sub-region.

2. The holographic waveguide lens according to claim 1, wherein a thickness of the polymer-dispersed liquid crystal holographic grating is 2 μm to 10 μm.

3. The holographic waveguide lens according to claim 1, wherein the in-coupling grating and the out-coupling grating are arranged along a first direction, and lengths of the out-coupling grating, the first transparent electrode, and the second transparent electrode in the first direction are equal.

4. The holographic waveguide lens according to claim 1, wherein thicknesses of the first lens substrate and the second lens substrate are 0.5 mm to 4 mm.

5. The holographic waveguide lens according to claim 1, wherein the number of the plurality of sub-regions is 5 to 15.

6. The holographic waveguide lens according to claim 1, wherein a voltage of each sub-region is independently controlled.

7. A preparation method of the holographic waveguide lens according to claim 1, comprising:
mixing a photopolymer monomer, a liquid crystal, and a photoinitiator in a light-shielded container uniformly to prepare a polymer-dispersed liquid crystal holographic grating raw material;
forming a first transparent electrode on a region of a first lens substrate corresponding to an out-coupling grating, wherein the first transparent electrode includes a plurality of sub-regions;
forming a second transparent electrode on a region of a second lens substrate corresponding to the out-coupling grating, wherein the second transparent electrode includes a plurality of sub-regions corresponding to the first transparent electrode;
stacking the first lens substrate, the polymer-dispersed liquid crystal holographic grating raw material, and the second lens substrate, and aligning the first transparent electrode opposite to the second transparent electrode to form a lens intermediate;
preparing a polymer-dispersed liquid crystal holographic grating in an in-coupling grating region and an out-coupling grating region using a holographic exposure method; and
setting a voltage between the first transparent electrode and the second transparent electrode for each sub-region based on an electro-optical response curve and a diffraction efficiency of the polymer-dispersed liquid crystal holographic grating for each sub-region to obtain the holographic waveguide lens.

8. The preparation method according to claim 7, wherein the setting a voltage between the first transparent electrode and the second transparent electrode for each sub-region based on an electro-optical response curve and a diffraction efficiency of the polymer-dispersed liquid crystal holographic grating for each sub-region comprises:
measuring the polymer-dispersed liquid crystal holographic grating using a liquid crystal display parameter tester to obtain the electro-optical response curve of the polymer-dispersed liquid crystal holographic grating;
calculating diffraction efficiencies required for different sub-regions of the out-coupling grating to achieve a uniform exit pupil for the lens intermediate; and
setting a voltage between the first transparent electrode and the second transparent electrode for different sub-regions based on the electro-optical response curve and the diffraction efficiencies required for different sub-regions of the out-coupling grating to obtain the holographic waveguide lens.

9. The preparation method according to claim 8, wherein the calculating diffraction efficiencies required for different sub-regions of the out-coupling grating to achieve a uniform exit pupil for the lens intermediate comprises:
setting a preset diffraction efficiency corresponding to each sub-region;
calculating a product of the preset diffraction efficiency corresponding to each sub-region and a remaining energy after coupling out from all sub-regions preceding the sub-region in the first direction, as an out-coupled energy of the sub-region; and
using a genetic algorithm to minimize a standard deviation of the out-coupled energies among the sub-regions, and calculating the diffraction efficiencies required for different sub-regions of the out-coupling grating.

10. The preparation method according to claim 8, wherein the diffraction efficiency of the polymer-dispersed liquid crystal holographic grating is adjustable between 5% and 99% with changes in an applied voltage.
